(19) United States
(12) Patent Application Publication
(10) Pub. No.: US 2010/0151298 A1
(43) Pub. Date: Jun. 17, 2010

(54) PROTON CONDUCTOR FOR FUEL CELL, ELECTRODE FOR FUEL CELL INCLUDING THE PROTON CONDUCTOR, AND FUEL CELL INCLUDING THE ELECTRODE

(75) Inventors: Suk-gi HONG, Suwon-si (KR); Myung-jin Lee, Seoul (KR); Kyung-jung Kwon, Suwon-si (KR); Duck-young Yoo, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/637,144

(22) Filed: Dec. 14, 2009

(30) Foreign Application Priority Data
Dec. 16, 2008 (KR) 10-2008-0128187

(51) Int. Cl. H01M 4/00; H01M 8/08

(52) U.S. Cl. 429/40; 429/46

(57) ABSTRACT

A proton conductor for a fuel cell, an electrode for a fuel cell that includes the proton conductor, and a fuel cell including the electrode of which the proton conductor includes a phosphoric acid-based material, and a C1-C20 ammonium perfluoroalkylsulfonate dissolved in the phosphoric acid-based material.

### CROSS-REFERENCE TO RELATED APPLICATION

This application claims the benefit of Korean Patent Application No. 10-2008-0128187, filed Dec. 16, 2008 in the Korean Intellectual Property Office, the disclosure of which is incorporated herein in its entirety by reference.

### BACKGROUND

1. Field

One or more embodiments relate to a proton conductor for a fuel cell, an electrode including the proton conductor, and a fuel cell including the electrode. More particularly, one or more embodiments relate to a proton conductor for a fuel cell that may increase oxygen permeability in an electrode, an electrode including the proton conductor, and a fuel cell including the electrode.

2. Description of the Related Art

A fuel cell produces an electromotive force as a result of a cell reaction between hydrogen and oxygen, which produces water as a reaction product. The hydrogen is produced due to the reaction of a source material, such as methanol and water, in the presence of a reforming catalyst. Fuel cells may be classified into polymer electrolyte membrane fuel cells (PEMFCs), direct methanol fuel cells (DMFCs), phosphoric acid fuel cells (PAFCs), molten carbonate fuel cells (MCFCs), solid oxide fuel cells (SOFCs), and the like according to the types of electrolyte and fuel used in the fuel cells.

Polymer electrolyte membrane fuel cells (PEMFCs) operate at 80° C., and NAFION® is generally used as a binder and proton conductor in electrodes of such fuel cells. If the temperature is increased from 80° C. to 130° C. or higher, the PEMFCs may simply operate without a humidifier, and CO poisoning of a catalyst used is decreased. However, when the temperature is higher than 130° C., the NAFION may not be used any longer. Thus, a novel binder and proton conductor needs to be employed instead of NAFION.

Phosphoric acid is currently used as an electrolyte and a proton conductor in electrodes of PEMFCs which operate at temperatures of 100° C. or higher. Although phosphoric acid is stable at temperatures up to 200° C. and has excellent proton conductivity, it has a low oxygen reduction rate. The oxygen reduction rate is low in phosphoric acid since phosphoric acid is adsorbed on the catalyst and has low oxygen solubility. Thus, an overvoltage is applied to a cathode due to the low oxygen reduction rate of the phosphoric acid.

Although a proton conductive medium using fluoroborate or fluoroheteroborate has been disclosed in U.S. Pat. No. 7,419,623, and US Patent Publication Nos. 2006/0027789 and 2008/0090132, there is still a need to improve the efficiency of fuel cells since such a proton conductive medium does not sufficiently improve the efficiency of fuel cells including the proton conductive medium.

### SUMMARY

One or more embodiments include a proton conductor for a fuel cell, which may improve the utilization ratio of a Pt catalyst, an electrode including the proton conductor, and a fuel cell including the electrode.

Additional aspects will be set forth in part in the description which follows and, in part, will be apparent from the description, or may be learned by practice of the one or more embodiments.

According to aspects of the invention, one or more embodiments may include a proton conductor for a fuel cell, the proton conductor including: a phosphoric acid-based material; and a C1-C20 ammonium perfluoroalkylsulfonate dissolved in the phosphoric acid-based material.

According to aspects of the invention, one or more embodiments may include electrode for a fuel cell, including: a phosphoric acid-based material; a C1-C20 ammonium perfluoroalkylsulfonate dissolved in the phosphoric acid-based material; a catalyst; and a binder.

According to aspects of the invention, one or more embodiments may include a fuel cell including a cathode, an anode, and an electrolyte membrane disposed between the cathode and the anode, wherein at least one of the cathode and the anode includes the proton conductor including a phosphoric acid-based material; and a C1-C20 ammonium perfluoroalkylsulfonate dissolved in the phosphoric acid-based material.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a fuel cell according to an example embodiment;

FIG. 2 is a schematic sectional view of a membrane electrode assembly (MEA) in the fuel cell of FIG. 1, according to an example embodiment;

FIG. 3 is a graph of voltage versus current density of fuel cells manufactured according to Examples 1 through 4 and Comparative Example 1; and

FIGS. 4 and 5 are graphs for evaluating the oxygen reduction reaction (ORR) of rotating disk electrodes (RDEs) impregnated with a 3.4 M phosphoric acid solution and a 0.1 M perchloric acid solution, respectively.

### DETAILED DESCRIPTION

Reference will now be made in detail to embodiments of the present invention, examples of which are illustrated in the accompanying drawings, wherein like reference numerals refer to the like elements throughout. The embodiments are described below in order to explain the present invention by referring to the figures.

One or more embodiments includes a proton conductor for a fuel cell. The proton conductor includes: a phosphoric acid-based material; and an additive (i.e., a reactant). The additive is dissolved in the phosphoric acid-based material and increases oxygen solubility of the phosphoric acid-based material to increase the amount of oxygen, which is supplied to a catalyst of a cathode.

The additive may be a C1-C20 ammonium perfluoroalkylsulfonate that increases oxygen solubility when dissolved in a phosphoric acid-based material, such as phosphoric acid, due to a fluorine-based group, and diffusion of oxygen in the electrode, that markedly improves the cell performance in a high-current density area, and that is stable at a high temperature. For example, the additive is stable in a temperature range of about 130 to about 200° C.

Examples of the C1-C20 ammonium perfluoroalkylsulfonate include ammonium trifluoromethansulfonate (CF₃SO₃NH₄), ammonium perfluorohexanesulfonate (CF₃(CF₂)₅SO₃NH₄), ammonium perfluoroethanesulfonate (CF₃(CF₂)₇SO₃NH₄), ammonium perfluorodecanesulfonate (C₁₀F₂₁SO₃NH₄), ammonium nonafluorobutanesulfonate (CF₃(CF₂)₃SO₃NH₄), tetrabutylammonium nonafluorobutanesulfonate, and the like.

The amount of the C1-C20 ammonium perfluoroalkylsulfonate may be in a range of about 1 to about 20 parts by weight based on 100 parts by weight of the proton conductor (i.e., the total weight of the phosphoric acid-based material and the C1-C20 ammonium perfluoroalkylsulfonate). If the amount of the C1-C20 ammonium perfluoroalkylsulfate is within the above range, the oxygen solubility of the phosphoric acid is significantly increased, and adsorption of phosphoric acid-based material is effectively prevented, without increase in cell resistance.

The phosphoric acid-based material may be phosphoric acid or C1-C20 organic phosphonic acid. Examples of the phosphoric acid include metaphosphoric acid, pyrophosphoric acid, orthophosphoric acid, triphosphoric acid, and tetraphosphoric acid. For example, the phosphoric acid may be orthophosphoric acid. Examples of the C1-C20 organic phosphonic acid include C1-C10 alkylphosphonic acids, such as methylphosphonic acid, ethylphosphonic acid, and propylphosphonic acid; vinylphosphonic acid; phenylphosphonic acid; or the like.

When the phosphoric acid or C1-C20 organic phosphonic acid is used in an aqueous solution, the concentration of the aqueous solution of the phosphoric acid or the C1-C20 organic phosphonic acid may be in a range of about 20 to about 100% by weight, for example, in a range of about 85 to about 100% by weight.

The proton conductor may be used in the preparation of an electrode. First, an electrode for a fuel cell, the electrode including the proton conductor described above, and a method of preparing the electrode will be described in detail. An electrode for a fuel cell, according to an embodiment, includes a catalyst layer. The catalyst layer includes the proton conductor; a catalyst; and a binder. In a fuel cell system using the electrode as a cathode, when air flows to the cathode, oxygen is dissolved in phosphoric acid and reduced in the catalyst in the electrode. When the concentration of oxygen is increased in the phosphoric acid, an oxygen reaction is accelerated, and thus, cell performance is improved.

The catalyst may include at least one of the group of catalyst metals consisting of Pt and Pt-based alloys, such as PtCo and PtRu, and any mixtures thereof. The catalyst may also be a supported catalyst in which at least one of the catalyst metals is disposed on a carbonaceous support. Carbon black may be used as the carbonaceous support, and the amount of the catalyst metal may be in a range of about 10 to about 70 parts by weight based on 100 parts by weight of the supported catalyst, i.e., the total amount of the catalyst metal and the support.

The binder may be any material that provides the catalyst layer of the electrode with binding force with respect to the support. Examples of the binder include poly(vinylidene fluoride), polytetrafluoroethylene (PTFE), a tetrafluoroethylene-hexafluoroethylene copolymer, fluorinated ethylene propylene (FEP), polyurethane, styrene butadiene rubber (SBR), and any mixtures thereof, but the binder is not limited thereto. The amount of the binder may be in a range of about 0.001 to about 0.5 parts by weight based on 1 part by weight of the catalyst. If the amount of the binder is within this range, excellent cell performance is attained without resistance in the electrode.

In addition, the amount of C1-C20 ammonium perfluoroalkylsulfonate in the proton conductor may be in a range of about 1 to about 20 parts by weight based on 100 parts by the weight of the proton conductor. If the amount of the C1-C20 ammonium perfluoroalkylsulfonate is within this range, the oxygen solubility of the phosphoric acid is significantly increased, and adsorption of the phosphoric acid to the catalyst is effectively prevented, without an increase in cell resistance.

In the electrode according to the current embodiment, the amount of C1-C20 ammonium perfluoroalkylsulfonate may be in a range of about 1 to about 20 parts by weight based on 100 parts by weight of the total amount of the proton conductor including the phosphoric acid-based material and the C1-C20 ammonium perfluoroalkylsulfonate.

A method of preparing the electrode for a fuel cell according to the present embodiment will now be described. First, a composition for an electrode catalyst layer is prepared by mixing a catalyst, a binder, ammonium perfluoroalkylsulfonate, and a solvent. The solvent may be N-methylpyrrolidone (NMP), dimethylacetamide (DMAC), or the like, and the amount of the solvent may be in a range of about 1 to about 10 parts by weight based on 1 part by weight of the catalyst.

The composition for an electrode catalyst layer is coated on the surface of a carbon support to form an electrode. The carbon support may be fixed on a glass substrate to facilitate coating. The coating may be performed using a doctor blade coating method, a bar coating method, a screen printing method, or the like, but the coating method is not limited thereto.

The coated composition for an electrode catalyst layer is dried to evaporate the solvent at a temperature in a range of about 20 to about 150° C. The composition may be dried for about 10 to about 60 minutes, thereby completing the manufacture of the electrode. However, the drying time may vary according to the drying temperature.

In some cases, the electrode may be completed by coating the composition for the electrode catalyst layer including the catalyst, the binder, and the solvent on the surface of the carbon supporton, drying, and then impregnating the resulting structure with a mixture of a phosphoric acid-based material and a C1-C20 ammonium perfluoroalkylsulfonate.

The electrode for a fuel cell according to the current embodiment may be used in a high temperature PEMFC or PAFC.

Hereinafter, an electrolyte membrane for a fuel cell including the electrode according to the present embodiment will be described in detail.

A proton conductive polymer used to form the electrolyte membrane may be polybenzimidazole, a cross-linked product of polybenzoxazine-based compounds, a polybenzoxazine-polybenzimidazole copolymer, or the like, and any mixtures thereof.

A cross-linked product of polybenzoxazine-based compounds is disclosed in Korean Patent Application No. 2006-48303 (U.S. Patent Publication No. 2007/0275285, the disclosure of which is incorporated by reference). According to an embodiment, the cross-linked product of polybenzoxazine-based compounds may be prepared by polymerizing a first benzoxazine-based monomer represented by Formula 1 below and a second benzoxazine-based monomer represented by Formula 2 below using a cross-linking agent may be used.

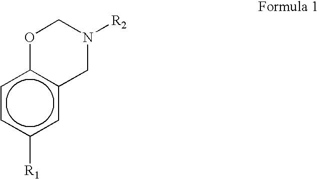

where, R₁ is a hydrogen atom, a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C2-C20 heteroaryl group, a substituted or unsubstituted C4-C20 cycloalkyl group or a substituted or unsubstituted C2-C20 heterocyclic group, a halogen atom, a hydroxy group, or a cyano group, where, R₂ is a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C7-C20 arylalkyl group, a substituted or unsubstituted C2-C20 heteroaryl group, a substituted or unsubstituted C2-C20 heteroarylalkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group,

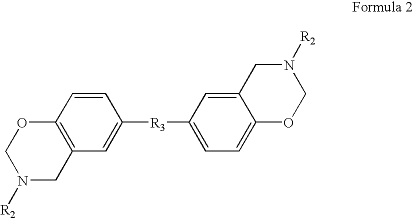

where, R₂ is a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C7-C20 arylalkyl group, a substituted or unsubstituted C2-C20 heteroaryl group, a substituted or unsubstituted C2-C20 heteroarylalkyl group, a substituted or unsubstituted C4-C20 carbocyclic group, a substituted or unsubstituted C4-C20 carbocyclic alkyl group, a substituted or unsubstituted C2-C20 heterocyclic group, or a substituted or unsubstituted C2-C20 heterocyclic alkyl group,

R₃ is one of or any mixture of a substituted or unsubstituted C1-C20 alkylene group, a substituted or unsubstituted C2-C20 alkenylene group, a substituted or unsubstituted C2-C20 alkynylene group, a substituted or unsubstituted C6-C20 arylene group, a substituted or unsubstituted C2-C20 heteroarylene group, —C(═O)—, —SO₂—, or the following Formula 3:

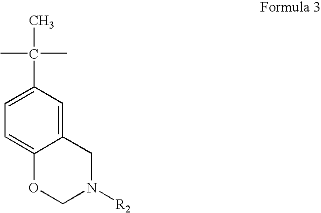

where, R₂ is defined above with reference to Formula 1.

The amount of the second benzoxazine-based monomer may be in a range of about 0.5 to about 50 parts by weight, for example, in a range of about 1 to about 10 parts by weight, based on 100 parts by weight of the first benzoxazine-based monomer.

A cross-linking compound used in the present embodiment may be any compound capable of cross-linking with a benzoxazine-based monomer. Examples of the cross-linking compound may include, but are not limited to, at least one of the group consisting of polybenzimidazole (PBI), polybenzthiazole, polybenzoxazole, polyimide, and any mixtures thereof. In addition, the amount of the cross-linking compound may be in a range of about 5 to about 95 parts by weight based on 100 parts by weight of the total weight of the first benzoxazine-based monomer and the second benzoxazine-based monomer.

The cross-linked polybenzoxazine-based compound according to the present embodiment may be prepared by polymerizing a first benzoxazine-based monomer represented by Formula 4 and a second benzoxazine-based monomer represented by Formula 5 with PBI.

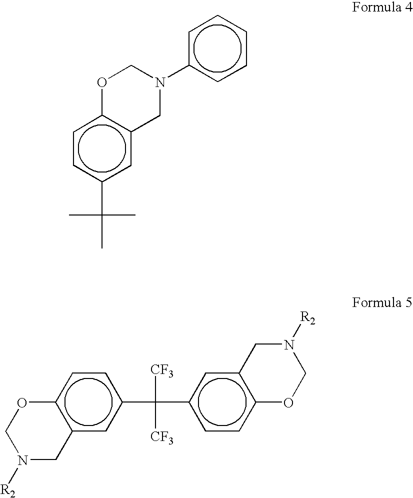

where, R₂ is a phenyl group.

According to the present embodiment, a proton conductor including a phosphoric acid-based material may be impregnated with the electrolyte membrane prepared using the materials described above and then assembled with the electrode to form a membrane electrode assembly (MEA).

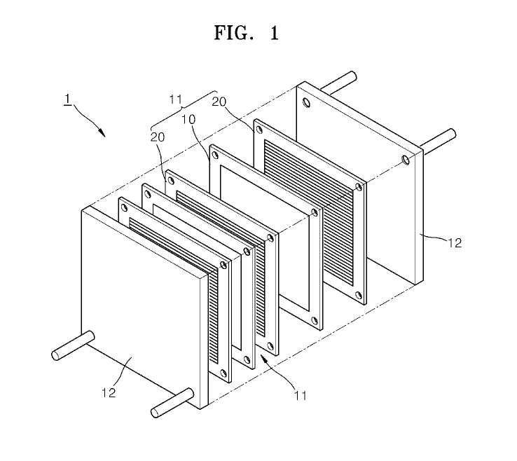

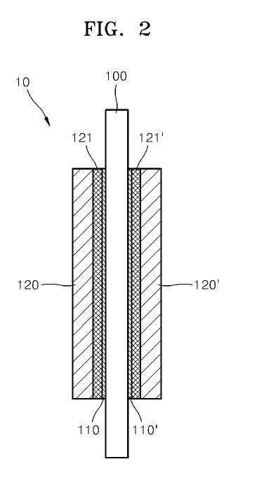

Hereinafter, a fuel cell according to an embodiment will be described in detail. FIG. 1 is an exploded perspective view of a fuel cell 1 according to an embodiment, and FIG. 2 is a schematic sectional view of a membrane electrode assembly (MEA) 10 included in the fuel cell of FIG. 1, according to an embodiment.

Referring to FIG. 1, the fuel cell 1 according to the present embodiment includes two unit cells 11 which are supported by a pair of holders or end plates 12. Each unit cell 11 includes a MEA 10 and a pair of bipolar plates 20 which are respectively disposed on opposite sides of the MEA 10 (i.e., in a thickness direction of the MEA 10). The bipolar plates 20 may be formed of a conductive material, such as a metal or carbon, and are assembled with the MEA 10. Thus, the bipolar plates 20 are current collectors and supply oxygen and fuel to catalyst layers of the MEA 10. In addition, the fuel cell 1 illustrated in FIG. 1 has two unit cells 11, but the number of the unit cells 11 is not limited thereto and may be up to several tens to hundreds according to the characteristics of the fuel cell 1.

Referring to FIG. 2, the MEA 10 includes a polymer electrolyte membrane for a fuel cell (hereinafter, “electrolyte membrane”) 100, catalyst layers 110 and 110′ respectively disposed on either side of the electrolyte membrane 100, i.e., in the thickness direction, first gas diffusion layers 121 and 121′ respectively formed on the catalyst layers 110 and 110′, and second gas diffusion layers 120 and 120′ respectively formed on the first gas diffusion layers 121 and 121′.

Each of the catalyst layers 110 and 110′, which are respectively a fuel electrode and an oxygen electrode, includes: a proton conductor for a fuel cell including a phosphoric acid-based material and a C1-C20 ammonium perfluoroalkylsulfonate which is dissolvable in the phosphoric acid-based material and has good oxygen solubility; a catalyst; and a binder.

The first gas diffusion layers 121 and 121′ and the second gas diffusion layers 120 and 120′ may be formed of, for example, a carbon cloth or carbon paper and diffuse oxygen and fuel supplied through the bipolar plates 20 throughout the catalyst layers 110 and 110′.

The fuel cell 1 including the MEA 10 operates at a temperature of about 100 to about 300° C. A fuel, for example, hydrogen, is supplied to the catalyst layer 110 (first catalyst layer) through one of the bipolar plates 20, and an oxidizer, for example, oxygen, is supplied to the catalyst layer 110′ (second catalyst layer) through the other bipolar plate 20. Then, the fuel is oxidized to produce protons in the first catalyst layer 110, the electrolyte membrane 100 conducts the protons to the second catalyst layer, and the protons electrochemically react with the oxidizer in the second catalyst layer 110′ to form water and generate electric energy.

In addition, hydrogen supplied as a fuel may be generated through the modification of hydrocarbon or alcohol, and oxygen supplied as an oxidizer may be supplied with air.

The electrolyte membrane 100 included in the MEA 10 will now be described. According to an embodiment, the electrolyte membrane 100 may include a phosphoric acid-based material and a proton conductor. In addition, the electrolyte membrane 100 may be any electrolyte membrane that is commonly used for a fuel cell. As described above, examples of the electrolyte membrane 100 include a polybenzimidazole electrolyte membrane, a polybenzoxazine-polybenzimidazole copolymer electrolyte membrane, a polytetrafluoroethylene (PTFE) electrolyte membrane, a cross-linked polybenzoxazine-based compound, and any mixtures thereof.

The one or more embodiments will now be described in greater detail with reference to the following examples. These examples are for illustrative purposes only and are not intended to limit the scope of the one or more embodiments.

### Synthesis Example 1

### Preparation of Benzoxazine-Based Monomer (Boa) Represented by Formula 4

1 mol of tertiary butylphenol, 2.2 mol of p-formaldehyde, and 1.1 mol of aniline were mixed and stirred without a solvent at 100° C. for 1 hour to produce a crude product. The crude product was washed twice with 1 N NaOH aqueous solution and once with distilled water, and dried with magnesium sulfate. The resultant was dried in a vacuum to obtain benzoxazine-based monomer represented by Formula 4 above at a yield of 95%.

### Synthesis Example 2 Preparation of benzoxazine-based monomer (HFA) represented by Formula 5 (R₂=phenyl group)

1 mol of 4,4′-hexafluoroisopropylidene diphenol (4,4′-HFIDPH), 4.4 mol of p-formaldehyde, and 2.2 mol benzene were mixed and stirred without a solvent at 100° C. for 1 hour to produce a crude product. The crude product was washed twice with 1 N NaOH aqueous solution and once with distilled water, and dried with magnesium sulfate. Then, the resultant was filtered, and then evaporated under reduced pressure. The resultant was dried in a vacuum to obtain benzoxazine monomer represented by Formula 5 above in which R₂ was a phenyl group at a yield of 96%.

### Example 1

### Preparation of Fuel Cell

An electrode for a fuel cell was prepared according to the following process. 1 g of a carbon-supported catalyst (PtCo/C), 0.4 g of 5 wt % polyvinylidenefluoride solution, 0.05 g of ammonium trifluoromethanesulfonate, and 4 g of NMP(N-methylpyrrolidone) were mixed and the viscosity of the mixture was adjusted for coating on a substrate to prepare a cathode slurry including 0.05 g of ammonium trifluoromethanesulfonate (equivalent to 0.05 parts by weight based on 1 part by weight of the catalyst).

The cathode slurry was coated on a microporous layer-coated carbon paper using a bar coater, and the resultant was dried while the temperature was increased from room temperature to 150° C. step by step, thereby producing a cathode. The loading amount of Pt in the cathode was 1.84 mg/cm².

1 g of a carbon-supported catalyst (Pt(30 wt %)Ru(23 wt %)/C), 0.4 g of 5 wt % polyvinylidenefluoride solution, 0.05 g of ammonium trifluoromethanesulfonate, and 3 g of NMP were mixed and the viscosity of the mixture was adjusted for coating on a substrate to prepare an anode slurry including 0.05 g of ammonium trifluoromethanesulfonate (equivalent to 0.05 parts by weight based on 1 part by weight of the Rt/Ru/C catalyst).

The anode slurry was coated on a microporous layer-coated carbon paper using a bar coater, and the resultant was dried while the temperature was increased from room temperature to 150° C. step by step, thereby producing an anode. The loading amount of Pt in the cathode was 0.69 mg/cm².

6 parts by weight of the BOA prepared in Synthesis Example 1, 0.3 parts by weight of the HFA prepared in Synthesis Example 2, and 3.7 parts by weight of polybenzimidazole (PBI) were blended, and the mixture was heated to 220° C. at a heating rate of 20° C./Hr and cured at the same temperature to prepare a cross-linked product of polybenzoxazine-based compound.

The cross-linked product of polybenzoxazine-based compound was impregnated with an 85 wt % phosphoric acid solution at 80° C. for 12 hours to form an electrolyte membrane having a thickness of 30 μm. Here, the amount of the phosphoric acid was about 421 parts by weight based on 100 parts by weight of the cross-linked product of polybenzoxazine-based compound.

In the cathode and anode prepared according to the processes described above, the amounts of ammonium trifluoromethanesulfonate were 4.09 parts by weight and 2.43 parts by weight, respectively, based on 100 parts by weight of ammonium trifluoromethanesulfonate and phosphoric acid.

A fuel cell was manufactured using the cathode, the anode, and the electrolyte membrane. The electrode area of the fuel cell was 7.84 cm², and the fuel cell was operated at 150° C. while air was supplied to the cathode at a rate of 250 ml/min and hydrogen was supplied to the anode at a rate of 100 ml/min.

### Example 2

### Preparation of Fuel Cell

A fuel cell was prepared and operated in the same manner as in Example 1 except that a cathode and an anode each including 0.1 g of ammonium trifluoromethanesulfonate (equivalent to 0.1 parts by weight based on 1 part by weight of the catalyst), instead of 0.05 g of trifluoromethanesulfonate (equivalent to 0.05 parts by weight based on 1 part by weight of the catalyst), were used.

In the cathode and anode prepared according to the processes described above, the amounts of ammonium trifluoromethanesulfonate were 8.25 parts by weight and 5.94 parts by weight, respectively, based on 100 parts by weight of ammonium trifluoromethanesulfonate and phosphoric acid.

### Example 3

### Preparation of Fuel Cell

A fuel cell was prepared and operated in the same manner as in Example 1 except that a cathode and an anode each including 0.03 g of ammonium trifluoromethanesulfonate (equivalent to 0.053 parts by weight based on 1 part by weight of the catalyst), instead of 0.05 g of trifluoromethanesulfonate (equivalent to 0.05 parts by weight based on 1 part by weight of the catalyst), were used.

In the cathode and anode prepared according to the processes described above, the amounts of ammonium trifluoromethanesulfonate were 2.69 parts by weight and 2.31 parts by weight, respectively, based on 100 parts by weight of ammonium trifluoromethanesulfonate and phosphoric acid.

### Example 4

### Preparation of Fuel Cell

A fuel cell was prepared and operated in the same manner as in Example 1 except that a cathode and an anode each including 0.2 g of ammonium trifluoromethanesulfonate (equivalent to 0.2 parts by weight based on 1 part by weight of the catalyst), instead of 0.05 g of trifluoromethanesulfonate (equivalent to 0.05 parts by weight based on 1 part by weight of the catalyst), were used.

In the cathode and anode prepared according to the processes described above, the amounts of ammonium trifluoromethanesulfonate were 18.34 parts by weight and 8.02 parts by weight, respectively, based on 100 parts by weight of ammonium trifluoromethanesulfonate and phosphoric acid.

### Comparative Example 1

### Preparation of Fuel Cell

A fuel cell was prepared and operated in the same manner as in Example 1, except that ammonium trifluoromethanesulfonate was not used to form the electrodes.

For the fuel cells prepared according to Examples 1 through 4 and Comparative Example 1, the loading amounts of Pt, the doping amounts of phosphoric acid (PA), and the voltages at different current densities are shown in Table 1 below.

TABLE 1

| | | | | | | | | | Comparative | |
|---|---|---|---|---|---|---|---|---|---|---|
| | Example 1 | | Example 2 | | Example 3 | | Example 4 | | Example 1 | |
| Item | anode | cathode | anode | cathode | anode | cathode | anode | cathode | anode | cathode |
| Loding amount of | 0.69 | 1.84 | 0.77 | 1.71 | 0.98 | 1.79 | 0.53 | 2.13 | 0.92 | 1.77 |
| Pt (mgPt/cm²) | | | | | | | | | | |

| Doping amount of | | 421 | 371 | 379 | 370 | 387 |
|---|---|---|---|---|---|---|
| PA | | | | | | |
| (parts by weight) | | | | | | |
| voltage | @0.3 A/cm² | 0.701 | 0.699 | 0.667 | 0.657 | 0.665 |
| | @1 A/cm² | 0.505 | 0.511 | 0.421 | 0.391 | 0.377 |

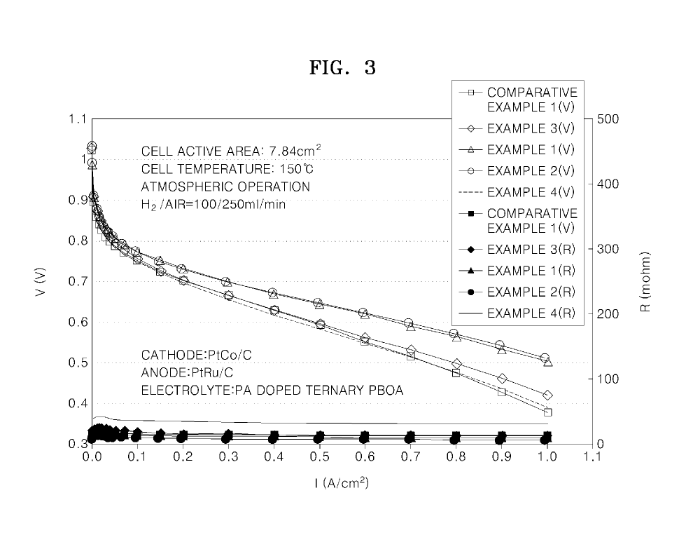

The voltages of the fuel cells prepared in Examples 1 through 4 and Comparative Example 1 were measured at different current densities. The results are shown in FIG. 3. Referring to FIG. 3, for example, Example 3 (V) and Example 3 (R) denote the voltage and resistance, respectively, of the fuel cell manufactured in Example 3.

Referring to FIG. 3, at a current density of 0.3 A/cm², the voltage characteristics of the fuel cells according to Examples 1 through 4 are better than or equivalent to (depending on the added amount) the voltage characteristics of the fuel cell according to Comparative Example 1. The voltage characteristics of the fuel cells manufactured according to Examples 1 through 4 using ammonium perfluoroalkylsulfonate are markedly improved at current densities of 1 A/cm² or higher.

The electrochemical surface area (ECSA) of the catalyst was measured for the electrodes manufactured according to Examples 1 and 2 and Comparative Example 1. The results are shown in Table 2 below. A phosphoric acid solution was used as the electrolyte, and the scanning rate was about 50 mV/s.

TABLE 2

| | | | Comparative |
|---|---|---|---|
| Items | Example 1 | Example 2 | Example 1 |
| Amount of Pt loaded on | 1.84 | 1.71 | 1.77 |
| cathode (mg/cm²) | | | |
| ECA (m²/g) | 594.12 | 622.02 | 438.93 |
| Pt utilization ratio (%) | 29.7 | 33.5 | 22.8 |

Referring to Table 2, the surface area of the Pt catalyst was about 66 m2/g. Referring to the amount of charge of a hydrogen adsorption peak (the area calculated by subtracting the current level of an electric double layer ranging over a positive current interval of 0.4˜0.8V as the background level from a positive current interval of 0.05˜0.4 V used to calculate the ECSA of the Pt catalyst, it is clear that the ECSA of the Pt catalyst increased when ammonium trifluoromethanesulfonate was added compared to when Pt was used alone. The increase in the surface area of the Pt catalyst is due to the combination of ammonium trifluoromethanesulfonate and phosphate to adsorb onto Pt.

### Example 5

### Manufacture of RDE Electrode and Evaluation of ORR Activity

A carbon-supported catalyst Pt/C and ammonium trifluoromethanesulfonate were mixed in a weight ratio of 9:1 and then with a mixture of polyvinylidenefluoride in NMP to prepare a slurry for a rotating disk electrode (RDE). The slurry was deposited and coated on a glassy carbon electrode used as a substrate for the RDE, and dried to complete the manufacture of the RDE.

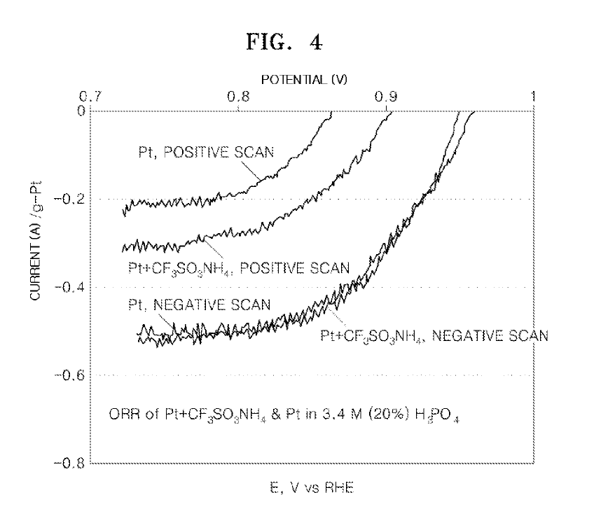

In order to investigate the difference in oxygen reduction reaction (ORR) between the electrode containing ammonium trifluoromethanesulfonate and an electrode not containing ammonium trifluoromethanesulfonate, the electrode (RDE) containing ammonium trifluoromethanesulfonate was impregnated with a 20 wt % (3.4 M) phosphoric acid solution used as an electrolyte, and the ORR activity of the catalyst was evaluated. In addition, the electrode not containing ammonium trifluoromethanesulfonate was manufactured using the same method as described above, and then impregnated with a 20 wt % (3.4 M) phosphoric acid solution, and the ORR activity of the catalyst was evaluated. The results are shown in FIG. 4.

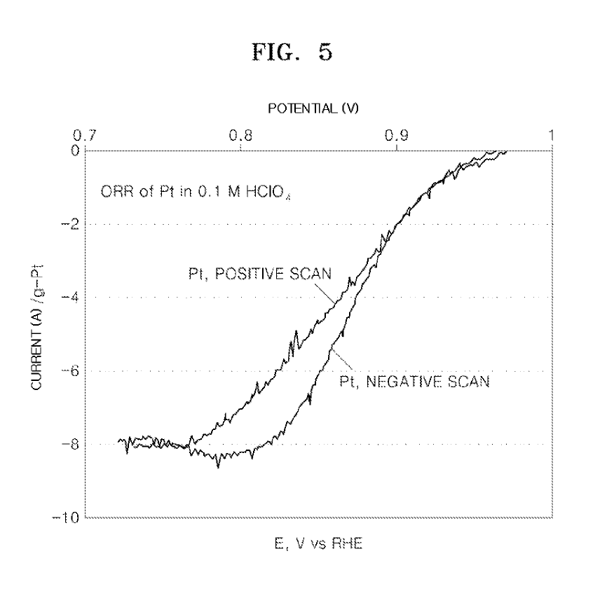

In order to investigate an effect of the adsorption of negative ions of phosphoric acid, the RDE using the Pt catalyst was impregnated with a 0.1 M diluted perchloric acid (HClO₄) solution, which is known not to adsorb negative ions of perchloric acid onto Pt, and the ORR activity of the catalyst was evaluated. The results are shown in FIG. 5. FIGS. 4 and 5 are graphs for evaluating the oxygen reduction reaction (ORR) of RDEs impregnated with the 3.4M phosphoric acid solution and the 0.1 M perchloric acid solution, respectively.

The ORR activity was evaluated based on the amount of current recorded while scanning each RDE in the electrolyte saturated with oxygen in a negative scan direction starting at an open circuit voltage (OCV) (scan rate: 1 mV/s, electrode rotation rate: 100 rpm).

For the RDE in the 0.1 M HClO₄ electrolyte, which is known not to adsorb negative ions of perchloric acid onto the Pt catalyst, there is little difference in ORR starting potential between the positive and negative scan directions as shown in FIG. 5. For the Pt/C electrode in the 3.4 M phosphoric acid electrolyte in which a large number of negative ions are adsorbed, a difference in ORR starting potential between the scan directions was measured to be 80 mV as shown in FIG. 4.

For the electrodes according to embodiments, which include ammonium trifluoromethanesulfonate (CF₃SO₃NH₄) and Pt/C, the difference in potential according to the scan directions was 50 mV as shown in FIG. 4, indicating an excellent effect of preventing the adsorption of negative ions of phosphoric acid due to the presence of the CF₃SO₃NH₄ according to aspects of the invention.

As described above, according to the one or more of the above embodiments, when ammonium perfluoroalkylsulfonate is used to manufacture an electrode for a fuel cell, oxygen solubility in a phosphoric acid-based material of the electrode increases, and oxygen concentration in the phosphoric acid-based material increases. Thus, the oxygen reduction reaction (ORR) occurring in the cathode increases. In addition, the adsorption of negative phosphoric ions onto the catalyst is decreased, thereby raising the utilization of the Pt catalyst. As a result, a fuel cell having a higher efficiency due to an improved cell voltage may be manufactured using the electrode.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A proton conductor for a fuel cell, the proton conductor comprising:
a phosphoric acid-based material; and
a C1-C20 ammonium perfluoroalkylsulfonate dissolved in the phosphoric acid-based material.

2. The proton conductor of claim 1, wherein the C1-C20 ammonium perfluoroalkylsulfonate comprises at least one selected from the group consisting of ammonium trifluoromethanesulfonate (CF₃SO₃NH₄), ammonium perfluorohexanesulfonate, ammonium perfluorooctanesulfonate (CF₃(CF₂)₇SO₃NH₄), ammonium perfluorodecanesulfonate (C₁₀F₂₁SO₃NH₄), ammonium nonafluorobutanesulfonate, tetrabutylammonium nonafluorobutanesulfonate, and any mixtures thereof.

3. The proton conductor of claim 1, wherein the amount of the C1-C20 ammonium perfluoroalkylsulfonate is in a range of about 1 to about 20 parts by weight based on 100 parts by weight of the proton conductor.

4. The proton conductor of claim 1, wherein the phosphoric acid-based material comprises phosphoric acid or a C1-C20 organic phosphonic acid.

5. An electrode for a fuel cell, comprising:
a phosphoric acid-based material;
a C1-C20 ammonium perfluoroalkylsulfonate dissolved in the phosphoric acid-based material;
a catalyst; and
a binder.

6. The electrode of claim 5, wherein the catalyst comprises either at least one of Pt, PtCo, PtRu, PtFe, PtNi, and any mixtures thereof, or a supported catalyst containing the at least one catalyst metal disposed on a carbonaceous support.

7. The electrode of claim 5, wherein the binder comprises at least one selected from the group consisting of poly(vinylidenefluoride), polytetrafluoroethylene (PTFE), a tetrafluoroethylene-hexafluoroethylene copolymer, fluorinated ethylene propylene (FEP), polyurethane, styrene butadiene rubber (SBR), and any mixtures thereof.

8. The electrode of claim 5, wherein the amount of the C1-C20 ammonium perfluoroalkylsulfonate in the proton conductor is in a range of about 1 to about 20 parts by weight based on 100 parts by weight of the proton conductor.

9. A fuel cell comprising:
a cathode;
an anode; and
an electrolyte membrane disposed between the cathode and the anode,
wherein at least one of the cathode and the anode comprises a proton conductor, the proton conductor comprising:
a phosphoric acid-based material; and
a C1-C20 ammonium perfluoroalkylsulfonate dissolved in the phosphoric acid-based material.

10. The fuel cell of claim 9, wherein the C1-C20 ammonium perfluoroalkylsulfonate comprises at least one selected from the group consisting of ammonium trifluoromethanesulfonate (CF₃SO₃NH₄), ammonium perfluorohexanesulfonate, ammonium perfluorooctanesulfonate (CF₃(CF₂)₇SO₃NH₄), ammonium perfluorodecanesulfonate (C₁₀F₂₁SO₃NH₄), ammonium nonafluorobutanesulfonate, tetrabutylammonium nonafluorobutanesulfonate, and any mixtures thereof.

11. The fuel cell of claim 9, wherein the amount of the C1-C20 ammonium perfluoroalkylsulfonate is in a range of about 1 to about 20 parts by weight based on 100 parts by weight of the proton conductor.

12. The fuel cell of claim 9, wherein the phosphoric acid-based material comprises phosphoric acid or a C1-C20 organic phosphonic acid.
